(19) United States
(12) Patent Application Publication
(10) Pub. No.: US 2025/0108947 A1
(43) Pub. Date: Apr. 3, 2025

(54) Cartoning machine

(71) Applicant: PLUSLINE S.R.L., Zola Predosa (IT)

(72) Inventors: Christian ZAGNONI, Calcara Valsamoggia (IT); Leonardo STAMATI, Bologna (IT)

(21) Appl. No.: 18/724,618

(22) PCT Filed: Feb. 9, 2023
(86) PCT No.: PCT/IT2023/050040

§ 371 Date: Jun. 27, 2024

(30) Foreign Application Priority Data
Feb. 17, 2022 (IT) 102022000002918

(51) Int. Cl. B65B 43/14; B65B 43/18; B65B 43/30; B65B 43/46

(52) U.S. Cl. CPC B65B 43/145; B65B 43/185; B65B 43/305; B65B 43/46

(57) ABSTRACT

Cartoning machine comprising means (GD, GS) for picking up and transporting the cardboard dies in use comprising two independent units (GD, GS) for picking up and transporting the cardboard dies.

The present invention relates to a cartoning machine.

It is known that a cartoning machine, also known as “case packer”, is intended to package products inside cardboard boxes. Typically, a cartoning machine comprises: a product entry station; a magazine in which the cartons are stacked in an “extended” or flattened form; means for picking up the flat cartons from the magazin and putting them in shape or “unfolding”, suitable for picking up individual flat cartons from the magazine and arranging them in an open configuration which allows introducing the products inside them; means for folding the lateral, upper and lower flaps of the cartons opened after or before the insertion of the products inside the latter; means for gluing said flaps to close the cartons; and means for transporting the closed cartons along a predefined exit path.

A machine according to the present invention is a cartoning machine generally configured as described above, which implements technical solutions aimed at increasing its production.

This result has been achieved, in accordance with the present invention, by adopting the idea of making a machine having the characteristics indicated in claim 1. Other characteristics of the present invention are the subject of the dependent claims.

Thanks to the present invention, it is possible to increase the production of the cartoning machines, i.e. the number of complete packages per minute, without however compromising the quality of the packages thus produced.

These and further advantages and features of the present invention will be more and better understood by any person skilled in the art thanks to the following description and the annexed drawings, provided by way of example but not to be considered in a limiting sense, in which:

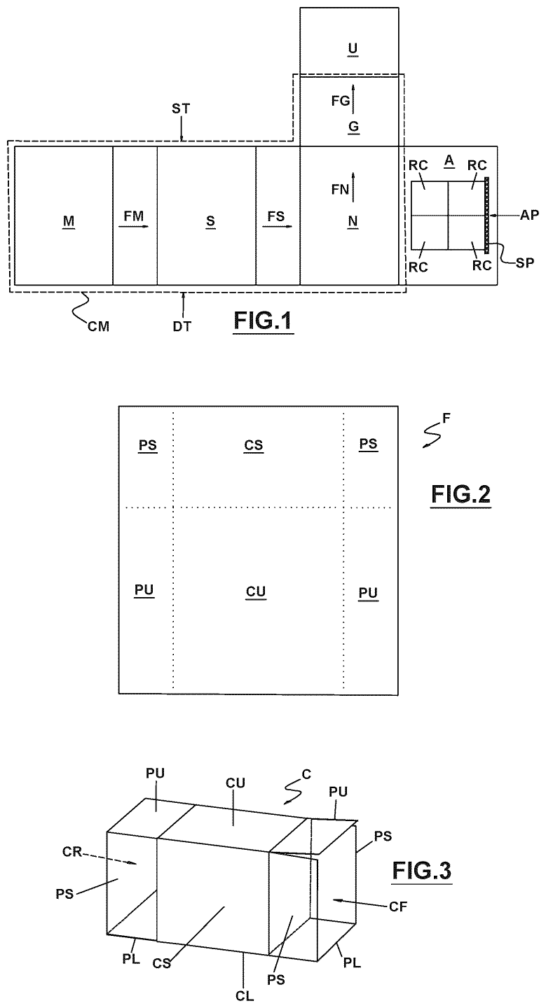

FIG. 1 represents a block diagram illustrating the operating stations of a cartoning machine according to the present invention seen in a top plan view;

FIG. 2 represents a schematic top plan view of a cardboard die;

FIG. 3 represents a schematic perspective view of an open cardboard box;

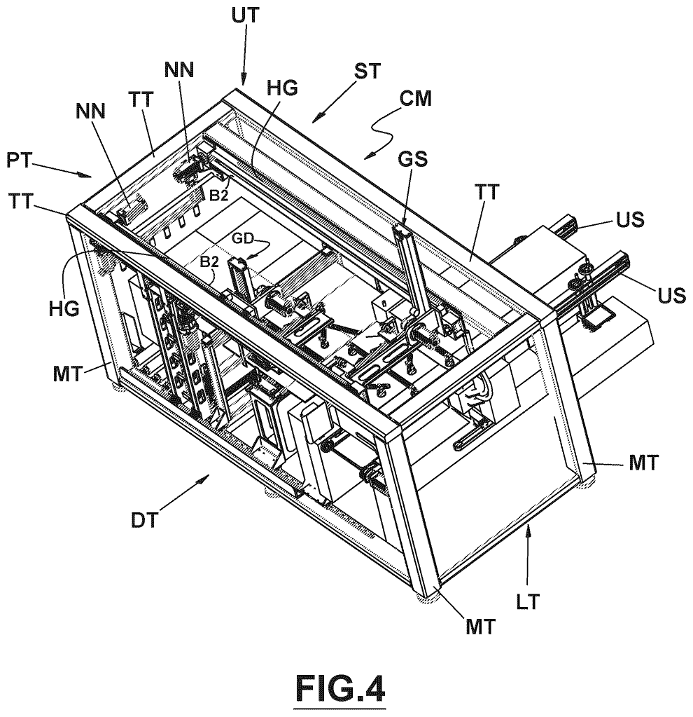

FIG. 4 represents a top perspective view of a cartoning machine in accordance with the present invention in possible operating configurations;

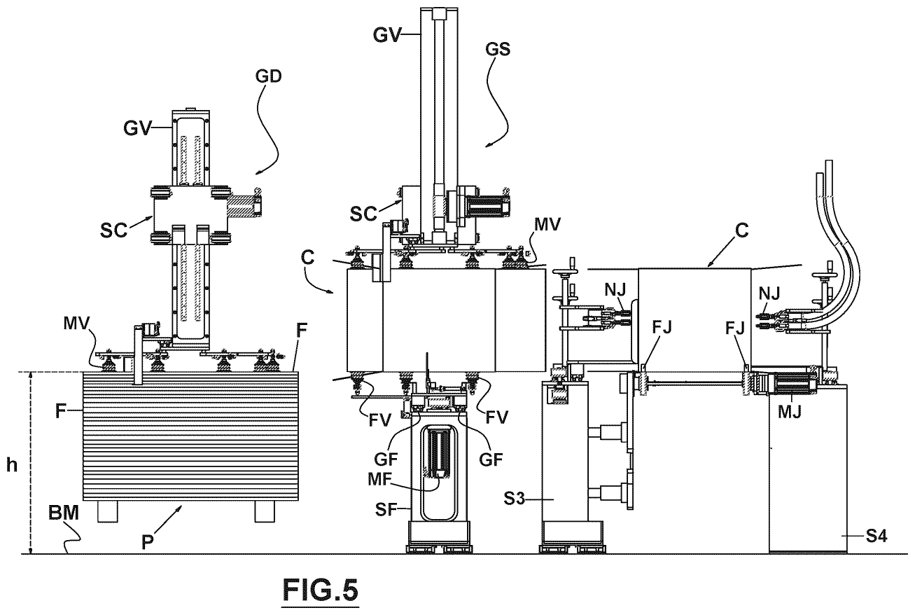

FIGS. 5-8 represent several operational configurations of the means for picking up and transporting the cardboard dies;

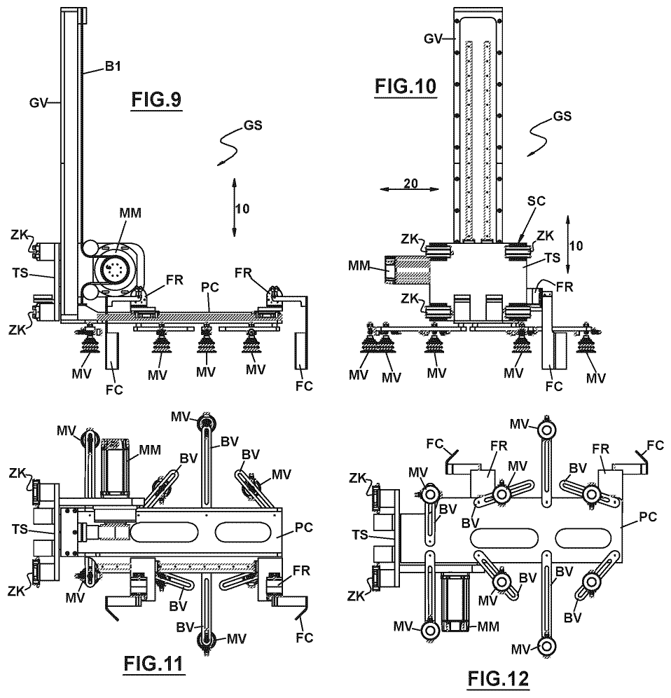

FIGS. 9-12 represent, in order, a side view, a rear view, a top view and a bottom view of a unit for picking up and transporting the cardboard dies;

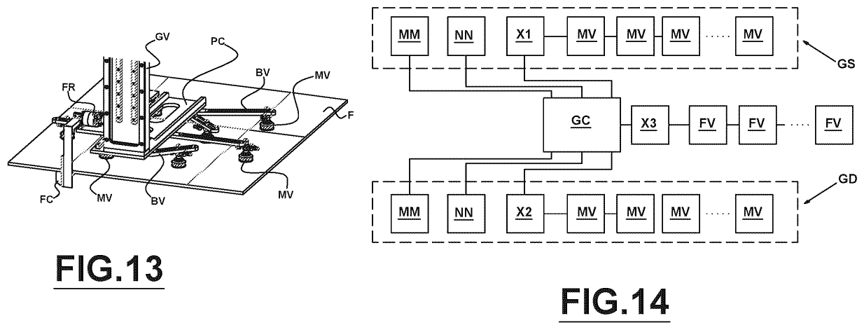

FIG. 13 is a detail showing a unit for picking up and transporting the cardboard dies in a step of engagement of a cardboard die;

FIG. 14 is a simplified block diagram relating to a possible control mode of the units for picking up and transporting the cardboard dies.

Reduced to its essential structure and with reference to the accompanying drawings, a cartoning machine according to the present invention comprises:
a magazine (M) configured to store stacks of flat cartons (F), also called “dies” in jargon;
means for picking up and transporting the dies (F);
an unfolding station (S), in which the dies (F) are shaped, assuming the configuration of an open substantially parallelepiped box (C) defined by an upper base (CU), a lower base (CL), two lateral bases (CS), a front base (CF) and a rear base (CR), in which the front base and the rear base are open but intended to be closed by flaps made up of appendices (PU, PL) of the upper and lower bases and bottom and appendices (PS) of the lateral bases: said lateral, upper and lower bases being defined by respective portions of the dies (F);
a product feeding station (A), where are fed the products (RC) intended to be packaged in the boxes (C) obtained from the dies (F);
an insertion station (N), where the products (RC) are inserted into the open boxes (C);
a station (G) for gluing the aforementioned flaps, i.e. for closing the boxes (C);
an exit station (U) for the completed packages.

In FIG. 1 the arrow “AP” shows the direction followed by the products (RC) in the feeding station (A). For example, the products (RC) are toilet paper rolls or kitchen towel rolls packaged in plastic or paper wrappers. For example, with per se known methods, the products (RC) are transported to the feeding station (A) by means of conveyors (represented by the arrow “AP”) and a pusher (SP) is provided in the feeding station (A) for pushing the products, along the direction (AP), towards the insertion station (N) to insert the products into the open boxes (C). The arrow “FM” shows the direction followed by the dies from the magazine (M) to the unfolding station (S), while the arrow “FS” shows the direction followed by the blanks from the unfolding station (S) to the insertion station (N). The arrow “FN” shows the direction followed by the opened and filled boxes from the inserting station (N) to the gluing station (G). The arrow “FG” shows the direction followed by the boxes from the gluing station (G) to the exit station (U).

The set formed by the magazine (M), the means for picking up and transporting the dies, the unfolding station (S), the insertion station (N) and the station (G) for gluing or closing the boxes, constitutes the so-called “machine body” (CM) represented by the perimetral dashed line in FIG. 1. The latter comprises a fixed structure made up of a metal frame which defines a lower side (LT), an upper side (UT), a right side (DT), a left side (ST), a front side (AT) and a back side (PT). With reference to the accompanying illustrative drawings, said metal frame is formed by a plurality of uprights (MT) and crosspieces (TT) which, in cooperation with each other, define said sides of the metal frame and, consequently, of the machine body (CM), which in FIG. 1 is highlighted by a discontinuous perimeter line. The right and left sides are defined in relation to the direction (FM) followed by the dies (F).

Inside the machine body a process takes place in which, according to an operating scheme known per se, each die (F) is taken from the magazine, by means of suitable picking and transport means, and is transported to the unfolding station (S), where it is unfolded, i.e. it is opened and shaped, obtaining an open box (C). In the unfolding station (S) there is a zone for temporary retention of a lower side of the die, defined by a plurality of lower pneumatic suction cups (FV) positioned on a corresponding support (SF). When a die (F) reaches the unfolding station (S), engaged by the means for picking up and transporting the dies, the portion of the die (F) which defines the lower base (CL) of the box (C) is pneumatically engaged by the lower suction cups (FV) which, therefore, pneumatically engage this portion of the die. Then, the means for picking up and transporting the blanks are raised, while the lower suction cups (FV) are moved horizontally in a direction orthogonal to the direction (FM) previously followed by the dies (i.e. in a direction orthogonal to the plane of the sheet in reference to FIGS. 5-8), so that the die is shaped, assuming the shape of an open box (C) with both the front and rear bases open. For this purpose, the lower suction cups (FV) are mounted on guides (GF) oriented according to said direction orthogonal to the direction followed by the dies. The movement of the lower suction cups (FV) is controlled by a corresponding electric motor (MF) positioned in the respective support (SF). Subsequently, the box (C) is transported to the insertion station (N), where the products (RC) to be packaged are inserted into the box (C) through the front base (CF) of the latter. Subsequently, the flaps (PS) are folded, by means of folders acting both on the front side and on the back side of the boxes (C), and on them, in the gluing station (G), a predetermined amount of glue is distributed. The flaps (PU) and (PL) are then folded over the flaps (PS), causing the front and rear bases of the boxes to close. Finally, the closed boxes are transported along the exit station (U). In the exit station (U) there are counterfacing motorized belts (US) that engage the boxes on the front and rear sides of the same, moving them towards the outside of the machine.

The means for picking up and transporting the cardboard dies consist of two independent picking and transport groups (GD, GS), one mounted sliding along the right side (DT) and the other mounted sliding along the left side (ST) of the machine body (CM). In practice, each dies picking and transport group is capable of picking up the individual dies (F) from the magazine (M) at a predetermined pick-up height (h), transporting them to the unfolding station (S) and, once unfolding is completed, it allows the open boxes (C), obtained by unfolding the dies, to be transported to the product insertion station (N). The height (h) for picking up the blanks from the magazine (M) is referred, for example, to the base (BM) on which the cartoning machine rests. Since the dies picking and transport groups are two independent groups, each of them, with a predefined timing difference, performs a complete picking cycle of a die (F) from the magazine (M), transport of the die to the unfolding station (S), and transport of the unfolded die to the insertion station (N), without leaving the die, until it reaches the insertion station (N). Therefore, for example, while a group (GS) for picking up and transporting the dies moves between the unfolding station (S) and the inserting station (N), the other group (GD) moves between the magazine (M) and the unfolding station (S).

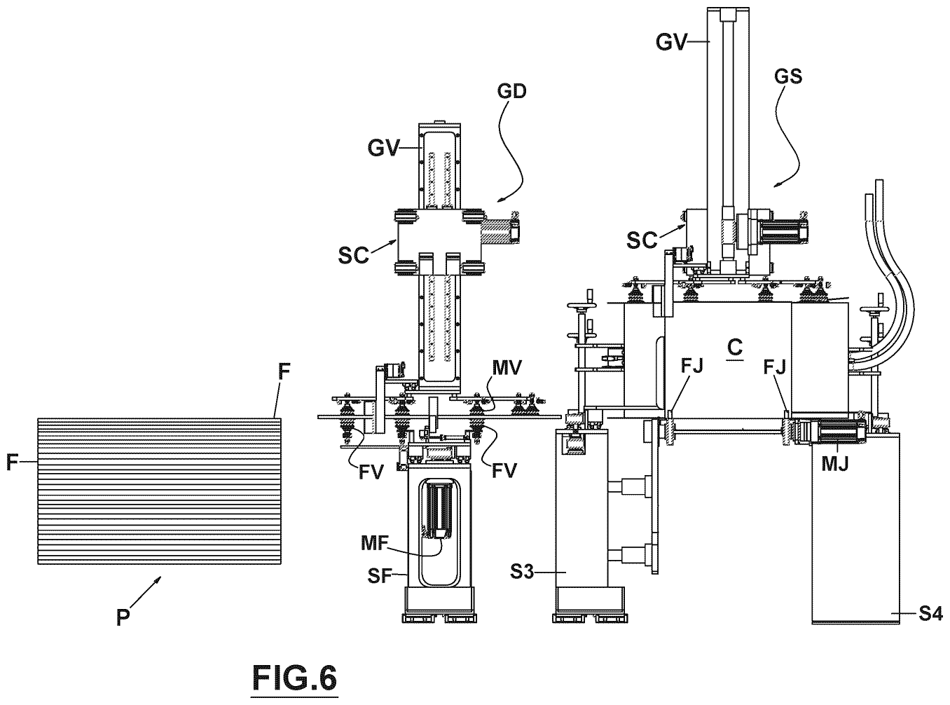

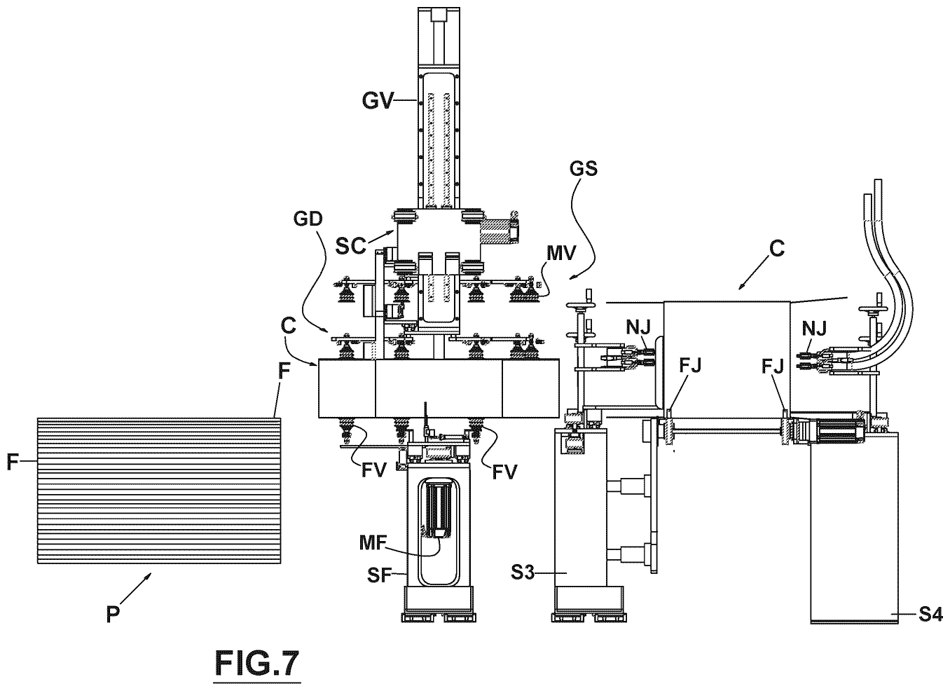

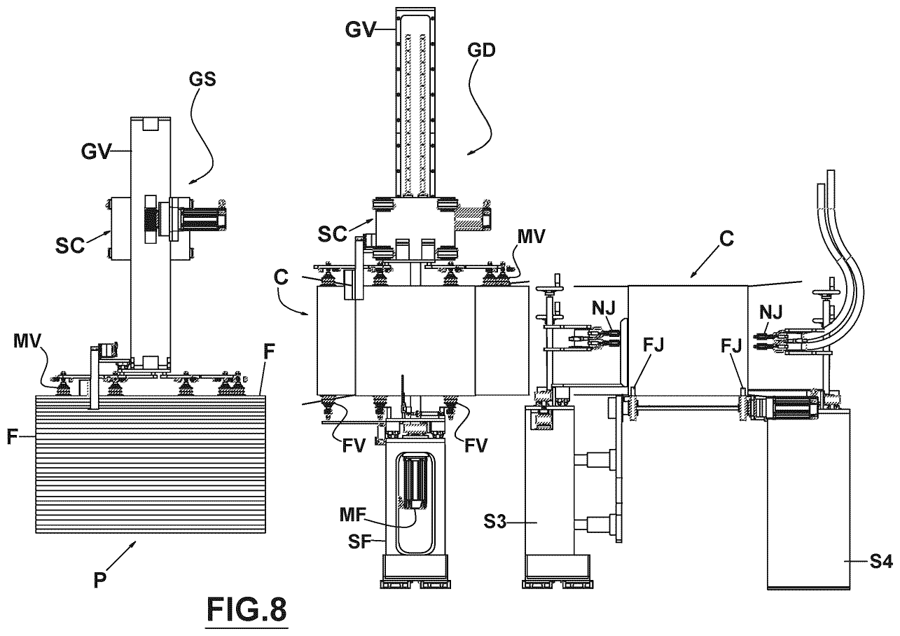

For example, with reference to FIGS. 5-8, in FIG. 5 the picking and transport group (GD) is in the process of picking up a cardboard die from the magazine (M) while the picking and transport group (GS) has completed the unfolding of a die blank in the unfolding station (S). In a subsequent phase (FIG. 6), while the group (GD) has transported the respective die to the unfolding station (S), the group (GS) has transported the open box (C) to the insertion station (N). In a subsequent phase (FIG. 7), the group (GS) has left the box (C) in the insertion station (N) and moves towards the magazine (M) while the group (GD) is unfolding the respective die in the unfolding station (S). In this phase, the picking and transport group directed towards the magazine (M) is at a higher height than the group that is operating the unfolding in the station (S) so as not to interfere with the latter. In a subsequent phase (FIG. 8), while the group (GD) has completed the unfolding of the respective die and is preparing to transport the open box (C) thus obtained towards the insertion station (N), the other group (GS) has reached the magazine (M) and is preparing to pick up a new die (F).

The return run of the groups (GD, GS) towards the magazine (M) can advantageously be performed with a higher speed than the forward run (run from the magazine M to the unfolding station S and to the insertion station N) bearing in mind that in the return run each of the two groups (GD, GS) is free, i.e. it does not engage any die.

This configuration of the dies pick-up and transport means allows, all other conditions being equal, to reduce the overall time required to carry out a complete production cycle compared to traditional cartoning machines in which two dies pick-up and transport groups are used but each of them is controlled in such a way as to move only between an operating station and the immediately adjacent operating station.

For example, the pick-up and transport unit (GS) mounted on the left side of the machine body comprises a plurality of pneumatic suction cups (MV) mounted on respective arms (BV) protruding from a first carriage (PC) which is slidably mounted along a rear surface (TS) of a second carriage (SC) by means of a respective vertical appendage (GV) which is moved, along the rear surface of the second carriage (SC), by a gear motor (MM). The latter, for example, can be fixed to the second carriage (SC) and connected to the first carriage (PC) via a belt drive (B1). Therefore, the first carriage (PC), and with it the pneumatic suction cups (MV), can be lowered and raised along the vertical direction while remaining constrained to the second carriage (SC). In this example, the second carriage (SC) is constrained to a horizontal guide (HG) formed on a cross member (TT) at the top left side of the machine body. The second carriage (SC) is connected to a respective gearmotor (NN). For example, the second carriage (SC) can be connected to the gear motor (NN) by means of a corresponding belt drive (B2). The horizontal guide (HG) extends between the magazine (M) and the insertion station (N). Therefore, the suction cups (MV) can be moved both vertically, as previously mentioned, and horizontally. In the drawings, the vertical movement of the suction cups (MV) is indicated by the double arrow “10” while the horizontal movement is indicated by the double arrow “20”. In the drawings, the reference “ZK” indicates pads arranged on a rear side (side facing the outside of the machine body) of the second carriage (SC) to facilitate its sliding along the respective guide (HG).

Preferably, two corresponding folders (FC) are mounted on two vertices of the first carriage (PC), each of which consists, for example, of a blade connected to a respective rotary actuator (FR) which controls the rotation thereof around a vertical axis. The function of the folders (FC) is described below.

A possible cycle for picking up and transporting a die operated by the group (GS) is as follows:
the second carriage (SC) is brought above the magazine (M) with the first carriage (PC) completely lifted, after which the first carriage (PC) is lowered, so as to bring the suction cups (MV) into contact with the highest die of the stack (P) present in the magazine;
then, the suction cups (MV) are activated, engaging this die;
subsequently, the second carriage (SC) is brought to the unfolding station (S), where the lower side of the blank is engaged by the fixed suction cups (FV), and the first carriage (PC) is lifted, determining the unfolding of the blank, i.e. the formation of the open box (C): the lifting of the first carriage (PC) in the unfolding station is programmed according to the height of the box (C);
at this point, the folders (FC) are activated, each of which determines the 45° rotation of a respective flap (PS) towards the other flap (PS) of the rear base (CR) of the open box (C): in this way, the flaps (PS) act as a support for the upper flaps (PU) in the subsequent step of transferring the open box (C) to the insertion station (N);
subsequently, the fixed suction cups (FV) are deactivated, freeing the lower side of the open box, and the second carriage (SC) is brought to the insertion station (N) where, subsequently, the suction cups (MV) are deactivated, freeing the open box (C) in which the products (RC) are inserted in known ways;
when the suction cups (MV) are deactivated in the station (N), the first carriage (PC) is further lifted, bringing the suction cups (MV) to a height higher than the unfolding height, i.e. with respect to the height reached to obtain complete unfolding of the die;
now, the second carriage (SC) is brought back to the magazine (M), preferably with a higher speed than the previous outward stroke, so that the whole unit (GS) is brought back to the magazine (M).

In the cycle for picking up and transporting the dies described above, the suction cups (MV) engage the upper side of the die in the magazine (M), in the unfolding station (S) and in the insertion station (N), without ever leaving the die while moving it from one station to another and releasing it only when it reaches the insertion station (N).

The group (GD) is structured and controlled like the group (GS), so its description is omitted, but the respective horizontal guide (HG) is formed on a top crossbar at the right side of the machine body.

Since in the return run to the magazine (M) the suction cups (MV) of each group (GS, GD) for picking up and transporting the dies are at a higher level, i.e. at a different level, compared to the unfolding level, there is no interference between the two groups moving in opposite directions one on the left side and the other on the right side of the machine body. The insertion of the products (RC) into the open box (C), the folding and gluing of the flaps (PS, PU, PL) and the transfer of the thus completed package can take place in ways known per se and therefore not described in more detail.

In FIGS. 5-8 protruding teeth (FJ) are shown which, in the product insertion station (N) and in the box (C) closing station (G), laterally contain the same boxes while they move along the direction (FN). For example, the teeth (FJ) can be teeth protruding from belts driven by an electric motor (MJ) and supported by respective bases (S3, S4). The same figures also schematically show nozzles (NJ) suitable for spraying glue on flaps of the boxes (C). As previously stated, the product insertion station and the box closing stations (C) can be configured in a manner known per se. However, it is understood that in accordance with possible alternative embodiments of the present invention, the station for closing the filled boxes could provided up in a different position, ie not immediately adjacent to the station for inserting the products. In this case, an exit can be provided for the filled but unclosed boxes and a separate operating station in which, for example, the filled boxes are closed with adhesive tape or even with glue.

In the block diagram of FIG. 14 the control unit (GC) controls the actuators (MM, NN) of said groups (GD, GS) and suction sources (X1, X2, X3) connected to the pneumatic suction cups (MV) of each group (GD, GS) and to the suction cups (FV) of the support (FS) of the unfolding station.

In practice, a cartoning machine according to the presente invention comprises:
a magazine (M) configured to store a stack (P) of cardboard dies (F);
an unfolding station (S), in which the cardboard dies (F) are put into shape assuming the shape of an open box (C);
a product (RC) feeding station (A), into which products (RC) intended to be packaged in boxes (C) obtained from the cardboard dies (F) are fed;
a product insertion station (N), in which the products (RC) are inserted into the open boxes (C);
an exit station (U) for the boxes with the products (RC) inside them;
means for picking up and transporting the cardboard dies (F) configured and controlled for moving the cardboard dies (F) along a path (FM, FS) between the magazine (M), the unfolding station (S) and the station (N) of product insertion;
means (CG) for controlling the means (GD, GS) for picking up and transporting the cardboard dies (F); and
said means for picking up and transporting the cardboard dies (F) comprise two independent units (GD, GS) for picking up and transporting the cardboard dies, each of which comprises gripping members (MV) configured to engage a cardboard die at a time in the magazine (M) and transport it along said path (FM, FS) keeping the cardboard die engaged in the opening station (S) and releasing it in the product insertion station (N) and said control means (GC) are programmed for controlling said independent units (GD, GS) for picking up and transporting the cardboard dies such that each of them engages one cardboard die at a time in the magazine (M) for transporting it along the said path (FM, FS) by keeping the cardboard die engaged in the unfolding station (S) and releasing it in the product insertion station (N).

A machine according to the present invention can also have one or more of the following features possibly combined between them:
said independent units (GD, GS) for picking up and transporting the dies are arranged one on a right side (DT) and one on a left side (ST) of the machine with respect to said path (FM, FS).
each independent unit (GD, GS) for picking up and transporting the cardboard dies comprises a plurality of pneumatic suction cups (MV) mounted on a first carriage (PC) which in turn is slidingly mounted on a second carriage (SC) and is moved by a respective gearmotor (MM) fixed to the second carriage (SC), the second carriage (SC) being constrained to a horizontal guide (HG) and being connected to a respective gearmotor (NN).
said horizontal guide (HG) extends between the magazine (M) and the product insertion station (N).
the second carriage (SC) is provided with skids to facilitate its sliding along the respective guide (HG).
said control means are programmed to operate said independent units (GD, GS) for picking up and transporting the cardboard dies according to respective operating cycles which are temporally offset by a predetermined value.

In practice, the details of execution can in any case vary in an equivalent way as regards the individual elements described and illustrated, without thereby departing from the protection offered by the present patent in accordance with the following claims.

1) Cartoning machine comprising:
a magazine (M) configured to store a stack (P) of cardboard dies (F);
an unfolding station (S), in which the cardboard dies (F) are put into shape assuming the shape of an open box (C);
a product (RC) feeding station (A), into which products (RC) intended to be packaged in boxes (C) obtained from the cardboard dies (F) are fed;
a product insertion station (N), in which the products (RC) are inserted into the open boxes (C);
an exit station (U) for the boxes with the products (RC) inside them;
means for picking up and transporting the cardboard dies (F) configured and controlled for moving the cardboard dies (F) along a path (FM, FS) between the magazine (M), the unfolding station (S) and the station (N) of product insertion;
means (CG) for controlling the means (GD, GS) for picking up and transporting the cardboard dies (F);
characterized in that said means for picking up and transporting the cardboard dies (F) comprise two independent units (GD, GS) for picking up and transporting the cardboard dies, each of which comprises gripping members (MV) configured to engage a cardboard die at a time in the magazine (M) and transport it along said path (FM, FS) keeping the cardboard die engaged in the opening station (S) and releasing it in the product insertion station (N) and in that said control means (GC) are programmed for controlling said independent units (GD, GS) for picking up and transporting the cardboard dies such that each of them engages one cardboard die at a time in the magazine (M) for transporting it along the said path (FM, FS) by keeping the cardboard die engaged in the case erection station (S) and releasing it in the product insertion station (N).

2) Machine according to claim 1 characterized in that the said independent units (GD, GS) for picking up and transporting the dies are arranged one on a right side (DT) and one on a left side (ST) of the machine with respect to said path (FM, FS).

3) Machine according to claim 1 characterized in that each independent unit (GD, GS) for picking up and transporting the cardboard dies comprises a plurality of pneumatic suction cups (MV) mounted on a first carriage (PC) which in turn is slidingly mounted on a second carriage (SC) and is moved by a respective gearmotor (MM) fixed to the second carriage (SC), the second carriage (SC) being constrained to a horizontal guide (HG) and being connected to a respective gearmotor (NN).

4) Machine according to claim 3 characterized in that said horizontal guide (HG) extends between the magazine (M) and the product insertion station (N).

5) Machine according to claim 4 characterized in that the second carriage (SC) is provided with skids to facilitate its sliding along the respective guide (HG).

6) Machine according to claim 1 characterized by the fact that the said control means are programmed to operate said independent units (GD, GS) for picking up and transporting the cardboard dies according to respective operating cycles which are temporally offset by a predetermined value.

7) Machine according to claim 2 characterized by the fact that the said control means are programmed to operate said independent units (GD, GS) for picking up and transporting the cardboard dies according to respective operating cycles which are temporally offset by a predetermined value.

8) Machine according to claim 3 characterized by the fact that the said control means are programmed to operate said independent units (GD, GS) for picking up and transporting the cardboard dies according to respective operating cycles which are temporally offset by a predetermined value.

9) Machine according to claim 4 characterized by the fact that the said control means are programmed to operate said independent units (GD, GS) for picking up and transporting the cardboard dies according to respective operating cycles which are temporally offset by a predetermined value.

10) Machine according to claim 5 characterized by the fact that the said control means are programmed to operate said independent units (GD, GS) for picking up and transporting the cardboard dies according to respective operating cycles which are temporally offset by a predetermined value.
